(19) United States
(12) Patent Application Publication
(10) Pub. No.: US 2008/0124534 A1
(43) Pub. Date: May 29, 2008

(54) Polyamide, Film, and Image Display Device

(75) Inventors: Seiya Sakurai, Kanagawa (JP); Hirohisa Hokazono, Kanagawa (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/663,090

(22) PCT Filed: Sep. 9, 2005
(86) PCT No.: PCT/JP05/17075

§ 371 Date: Mar. 16, 2007

(30) Foreign Application Priority Data
Sep. 16, 2004 (JP) 2004-269169

(51) Int. Cl. C08G 69/32; B32B 7/02; B32B 9/00

(52) U.S. Cl. 428/220; 428/690; 528/363

(57) ABSTRACT

A polyamide having from 25 to 90 mol % of a repeating unit of the following formula (1) and having from 10 to 75 mol % of a repeating unit of the following formula (2): formula (1) formula (2) wherein the ring and the ring are a monocyclic or polycyclic ring; R₁ and R₂ each are H or a substituent; R₃ and R₄ each are a substituent; p and q each are from 0 to 4; and L is 2,6-naphthylene, 3,3′-biphenylene or paraphenylene. The polyamide has good heat resistance and excellent optical and mechanical properties.

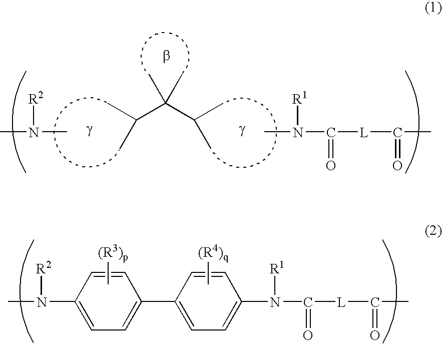

### TECHNICAL FIELD

The present invention relates to a polyamide having good heat resistance, excellent optical properties (e.g., transparency) and excellent mechanical properties, a film of the polyamide, and an image display device of good display quality that comprises the film.

### BACKGROUND ART

Recently, in the field of flat panel displays of, for example, liquid-crystal display devices and organic electroluminescent devices (hereinafter referred to as “organic EL devices”), using plastics in place of glass substrates is under investigation from the demand for improving the breakage resistance thereof and for reducing the weight and the thickness thereof. In particular, in the display devices for mobile information communication instruments of, for example, mobile information terminals such as mobile telephones, pocketsize personal computers and laptop personal computers, there is a great demand for plastic substrates.

The above-mentioned plastic substrates must be electroconductive. Recently, therefore, using plastic substrates fabricated by forming, on a plastic film, a transparent conductive layer of, for example, a semiconductor film of indium oxide, tin oxide or tin-indium alloy oxide, or a metal film of gold, silver or palladium alloy, or a composite film comprising a combination of the semiconductor film and the metal film, for electrode substrates in display devices is studied. Concretely, there are known plastic substrates fabricated by laminating a transparent conductive layer and further a gas-barrier layer on a plastic film of a heat-resistant amorphous polymer (e.g., modified polycarbonate (modified PC), polyether sulfone (PES), cyclo-olefin copolymer.

However, even though heat-resistant plastic films such as those mentioned above are used, plastic substrates having sufficient heat resistance could not be obtained. Specifically, when a conductive layer is formed on such a heat-resistant plastic film and then it is exposed to a high temperature not lower than 150° C. for imparting an alignment film thereto, then there occurs a problem in that the conductivity and the gas-barrier property of the layer may greatly lower and worsen.

Despite of the matter, recently, it is still inevitable to expose the film to a higher temperature in case where TFT is disposed in fabrication of active matrix-type image display devices, and plastic substrates having heat resistance of a higher level are needed. For example, as the method of exposing the film to a temperature not higher than 300° C., there are known a method of forming a polycrystalline silicon film at a temperature of 300° C. or lower by decomposing an SiH₄-containing gas in a mode of plasma decomposition; a method of forming a semiconductor film of a mixture of amorphous silicon and polycrystalline silicon on a polymer substrate through irradiation with energy beams; and a method of forming a polycrystalline silicon semiconductor layer on a plastic substrate by providing a thermal buffer layer thereon and irradiating it with pulse laser beams at a temperature not higher than 300° C. However, these methods of forming TFT at 300° C. or lower are still problematic in that their constitutions and the apparatus they require are complicated and expensive. Accordingly, in fact, it is desired to form TFT at high temperatures not lower than 300° C., and it is therefore desired to provide plastic substrate resistant to heat at 300° C. or higher. In addition, for stably expressing the electric characteristics of TFT, it is desired to form TFT at higher temperatures, and therefore it is desired to provide plastic substrates resistant to heat at 400° C. or higher from the viewpoint of reducing the number of failed products.

Further, recently, there is increasing a demand for high-resolution and large-panel color image display devices, and it is desired to form accurate micropatterns on plastic substrates. Plastic substrates are exposed to a temperature change when various functional layers are formed thereon, and it is desirable that plastic substrates could have a small dimensional change in such a temperature change. Specifically, plastic substrates are required to have a small linear thermal expansion coefficient.

On the other hand, an optical film to be used in image display devices is generally required to be substantially colorless and transparent. JP-A 3-28222 has a description relating to a polyarylate film derived from 9,9-bis(4-hydroxyphenyl)fluorene (hereinafter referred to as “bisphenol-fluorene”) and isophthalic acid and terephthalic acid. WO99/18141 has a description relating to a polyarylate film derived from an alkyl-substituted bisphenol-fluorene and isophthalic acid and terephthalic acid. JP-A 2002-145998 has a description relating to a polyarylate film derived from a bisphenol-fluorene in which the ortho-position of phenol is substituted with a halogen or the like. The polyarylates derived from such a substituted or unsubstituted bisphenol-fluorene and isophthalic acid and terephthalic acid all have a glass transition temperature (Tg) of around 300° C. or higher, and may provide flexible films of good transparency and good elongation at break. However, these films could not sufficiently satisfy the requirement of heat resistance needed for plastic substrates.

As opposed to these, polyparaphenylene-terephthalamide derivatives known as trade names of Twaron, Aramica, Mictron have good heat resistance and excellent mechanical properties, but tend to yellow. Therefore, they are not always satisfactory to the requirement of transparency needed for plastic substrates. Japanese Patent No. 3,185,503 has a description relating to a polyamide film formed through copolymerization of a polyamide of paraphenylene terephthalamide derivative with at most 20 mol % of repeating units derived from 9,9-bis(4-aminophenyl)fluorene (hereinafter referred to as “bisaniline-fluorene”) and an aromatic dicarboxylic acid. Introducing such a small amount of bisaniline-fluorene into the polyamide film improves the mechanical strength of the film, but the film still tends to yellow, and therefore, this does not sufficiently satisfy the requirement of transparency needed for plastic substrates.

JP-B 3-31732 has a description relating to a polyamide derived from 9,9-bis(4-aminophenyl)fluorene and isophthalic acid and terephthalic acid. This says that the polyamide may have an improved solubility in organic solvent when the proportion of isophthalic acid is increased but the heat resistance of the polymer lowers, and when the proportion of terephthalic acid is increased, then the heat-resistance of the polymer may be bettered but the solubility thereof tends to worsen. Therefore, the polymer is not satisfactory in point of the two necessary requirements of solubility in organic solvent and heat resistance thereof.

### DISCLOSURE OF THE INVENTION

The present invention has been made to solve the above-mentioned problems, and one object of the invention is to provide a polyamide having good heat resistance, excellent optical properties (e.g., transparency) and excellent mechanical properties. Another object of the invention is to provide a film having good heat resistance enough for formation of various functional layers at high temperatures thereon (for example, having a high glass transition temperature and having a low linear thermal expansion coefficient), having excellent optical properties (e.g., transparency), and having excellent mechanical properties enough for film formation. Still another object of the invention is to provide an image display device of high display quality that comprises the film.

We, the present inventors have assiduously studied for the purpose of attaining the above-mentioned objects, and, as a result, have found that a polyamide having a specific structure has good heat resistance, excellent optical properties (e.g., transparency) and excellent mechanical properties enough for plastic substrates for image display devices, and have completed the present invention.

Specifically, the subject matter of the invention is attained by the following measures:

[1] A polyamide having from 25 to 90 mol % of a repeating unit of the following formula (1) and having from 10 to 75 mol % of a repeating unit of the following formula (2):

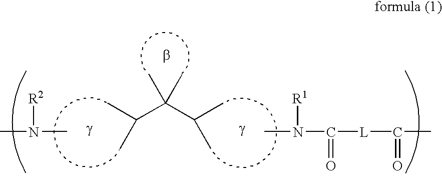

wherein the ring β and the ring γ each independently represent a monocyclic or polycyclic ring which may have a substituent; the two rings γ may be the same or different, both bonding to one quaternary carbon of the ring β; R¹ and R² each independently represent a hydrogen atom or a substituent; and L represents a linking group (in which the hydrogen atom may be substituted) having a structure of any of the following:

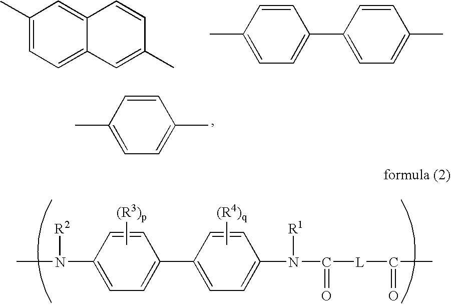

wherein R¹ and R² each independently represent a hydrogen atom or a substituent; p and q each independently indicate an integer of from 0 to 4; R³ and R⁴ each independently represent a substituent and they may bond to each other to form a ring; and L represents a linking group (in which the hydrogen atom may be substituted) having a structure of any of the following:

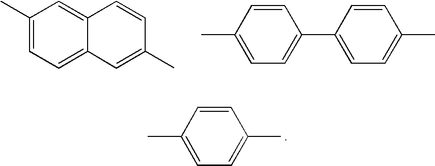

[2] A film comprising the polyamide of [1].

[3] An image display device comprising the film of [2].

The polyamide and the film of the invention have good heat resistance, excellent optical properties (e.g., transparency) and excellent mechanical properties. Since the film of the invention has a high glass transition temperature and a low linear thermal expansion coefficient, it is hardly influenced by the temperature change in forming a functional group thereon. Therefore, accurate micropatterns may be formed on the film and the film is applicable in a variety of fields. Further, the image display device of the invention may display high-quality images.

### BEST MODE FOR CARRYING OUT THE INVENTION

The polyamide and the film of the invention, and the image display device of the invention that comprises the film are described in detail hereinunder. The description of the constitutive elements of the invention given hereinunder is for some typical embodiments of the invention, to which, however, the invention should not be limited. In this description, the numerical range expressed by the wording “a number to another number” means the range that falls between the former number indicating the lowermost limit of the range and the latter number indicating the uppermost limit thereof.

[Polyamide and Method for Producing it]

The polyamide of the invention has from 25 to 90 mol % of a repeating unit of the following formula (1) and has from 10 to 75 mol % of a repeating unit of the following formula (2):

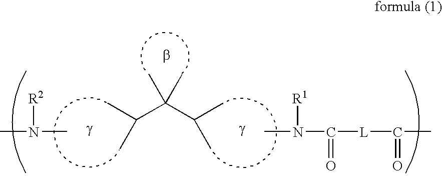

In formula (1), the ring β and the ring γ each independently represent a monocyclic or polycyclic ring which may have a substituent; and the two rings γ may be the same or different, both bonding to one quaternary carbon of the ring β. Preferably, the ring β is a polycyclic ring containing at least one aromatic ring. Also preferably, the ring γ is a ring comprising at least one aromatic ring. Preferred examples of the substituent that may be on the ring β and the ring γ are an alkyl group, an aryl group and a halogen atom, more preferably a chlorine atom, a bromine atom, a methyl group, an isopropyl group, a tert-butyl group and a phenyl group.

R¹ and R² each independently represent a hydrogen atom or a substituent, preferably a hydrogen atom or an alkyl group, more preferably a hydrogen atom.

L represents a linking group of any of a naphthylene, biphenylene or paraphenylene structure mentioned below, in which the hydrogen atom may be substituted. Preferred examples of the substituent in the naphthalene, biphenylene or paraphenylene structure are an alkyl group, an aryl group and a halogen atom, more preferably a methyl group, a chlorine atom and a bromine atom.

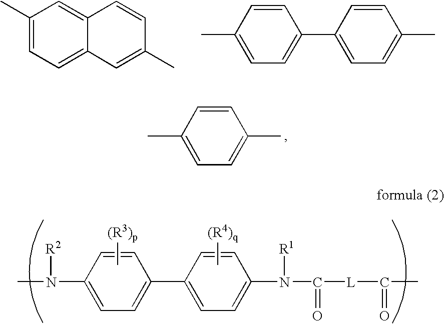

In formula (2), R¹ and R² each independently represent a hydrogen atom or a substituent, preferably a hydrogen atom or an alkyl group, more preferably a hydrogen atom.

p and q each independently indicate an integer of from 0 to 4, preferably from 1 to 4. R³ and R⁴ each independently represent a substituent. Preferred examples of the substituent are an alkyl group, an alkoxy group, an aryl group and a halogen atom, more preferably a methyl group, a methoxy group, a chlorine atom and a bromine atom. R³ and R⁴ may bond to each other to form a ring.

Like L in formula (1) mentioned above, L in formula (2) represents a linking group of any of the above-mentioned naphthylene, biphenylene or paraphenylene structure, in which the hydrogen atom may be substituted. Preferred examples of the substituent in the naphthylene, biphenylene or paraphenylene structure are an alkyl group, an aryl group and a halogen atom, more preferably a methyl group, a chlorine atom and a bromine atom.

Preferred examples of the repeating unit of formula (1) are those of the following formula (3) or (4):

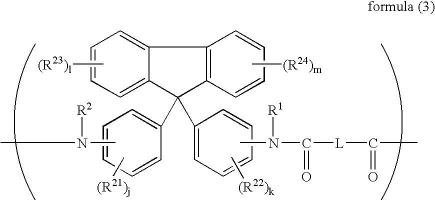

In formula (3), R²¹, R²², R²³ and R²⁴ each independently represent a substituent, and they may bond to each other to form a ring. j, k, l and m each independently indicate an integer of from 0 to 4. Preferred examples of the substituents are a halogen atom, an alkyl group and an aryl group, more preferably a chlorine atom, a bromine atom, a methyl group, an isopropyl group, a tert-butyl group and a phenyl group.

R¹ and R² each independently represent a hydrogen atom or a substituent, preferably a hydrogen atom or an alkyl group, more preferably a hydrogen atom.

Like that in formula (1), L represents a linking group of any of the above-mentioned naphthylene, biphenylene or paraphenylene structure, in which the hydrogen atom may be substituted. Preferred examples of the substituent in the naphthylene, biphenylene or paraphenylene structure are an alkyl group, an aryl group and a halogen atom, more preferably a methyl group, a chlorine atom and a bromine atom.

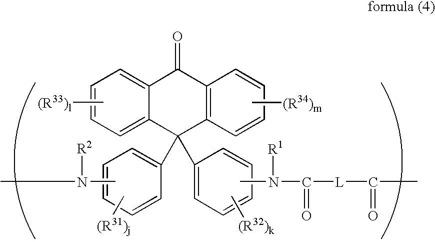

In formula (4), R³¹, R³², R³³ and R³⁴ each independently represent a substituent, and they may bond to each other to form a ring. j, k, l and m each independently indicate an integer of from 0 to 4. Preferred examples of the substituents are a halogen atom, an alkyl group and an aryl group, more preferably a chlorine atom, a bromine atom, a methyl group, an isopropyl group, a tert-butyl group and a phenyl group.

R¹ and R² each independently represent a hydrogen atom or a substituent, preferably a hydrogen atom or an alkyl group, more preferably a hydrogen atom.

Like that in formula (1), L represents a linking group of any of the above-mentioned naphthylene, biphenylene or paraphenylene structure, in which the hydrogen atom may be substituted. Preferred examples of the substituent in the naphthylene, biphenylene or paraphenylene structure are an alkyl group, an aryl group and a halogen atom, more preferably a methyl group, a chlorine atom and a bromine atom.

Preferred examples of the polyamide of the invention are mentioned below, to which, however, the invention should not be limited. The numerals given to the repeating units indicate the copolymerization ratio (mol %) of the polymer. PA-1 to PA-3 and PA-5 to PA-24 are bipolymers. PA-25 is a tripolymer and PA-4 and PA-26 are quarterpolymers.

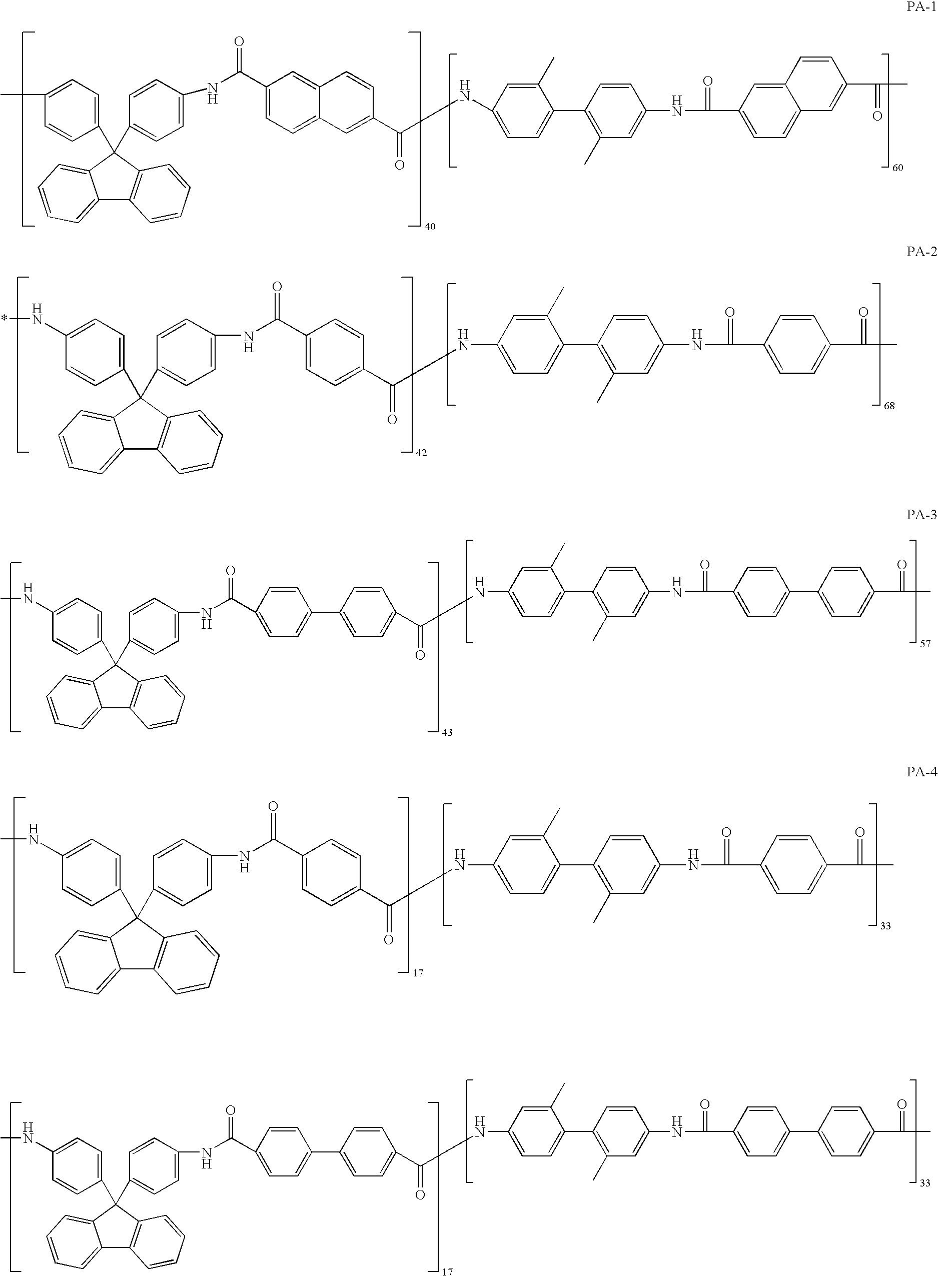

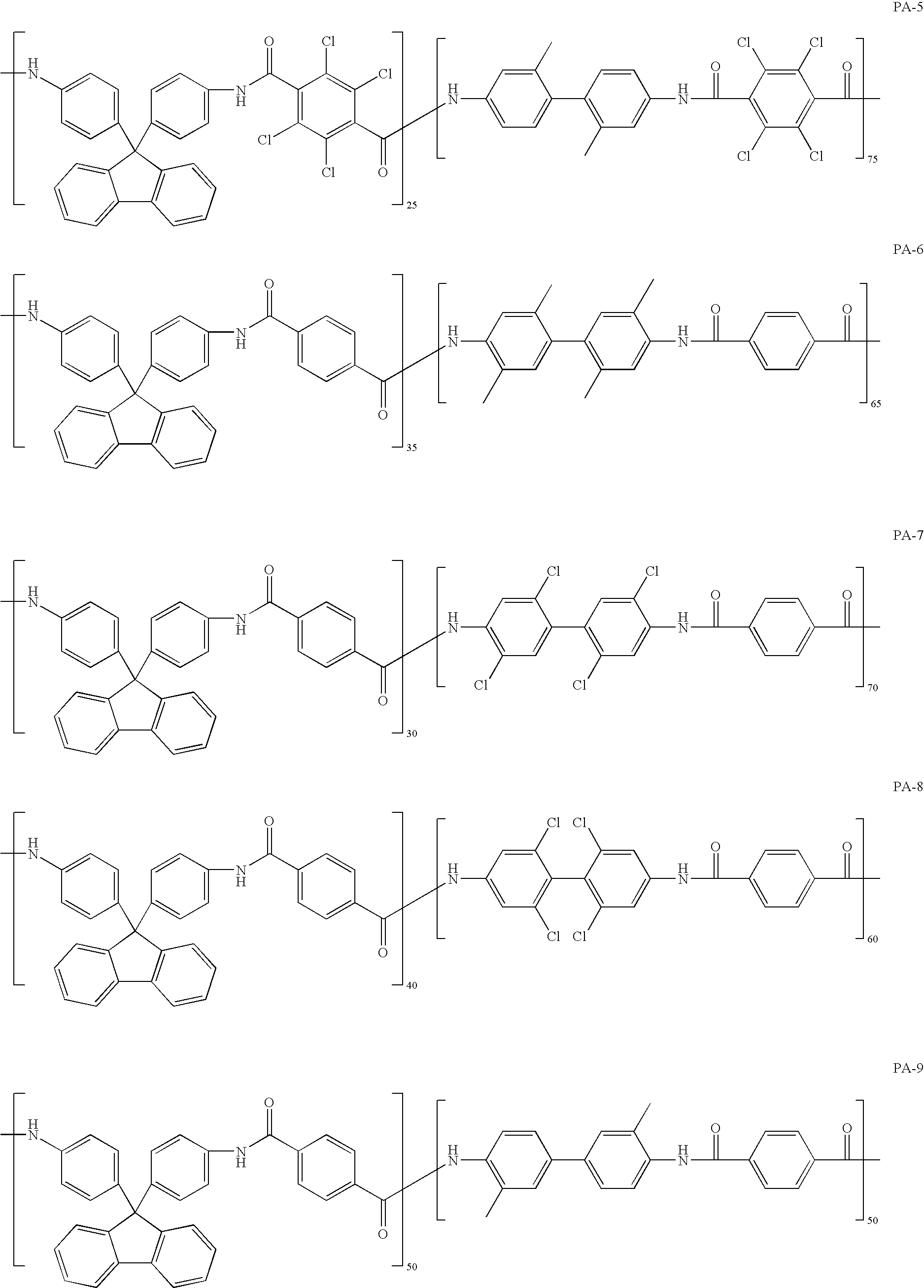

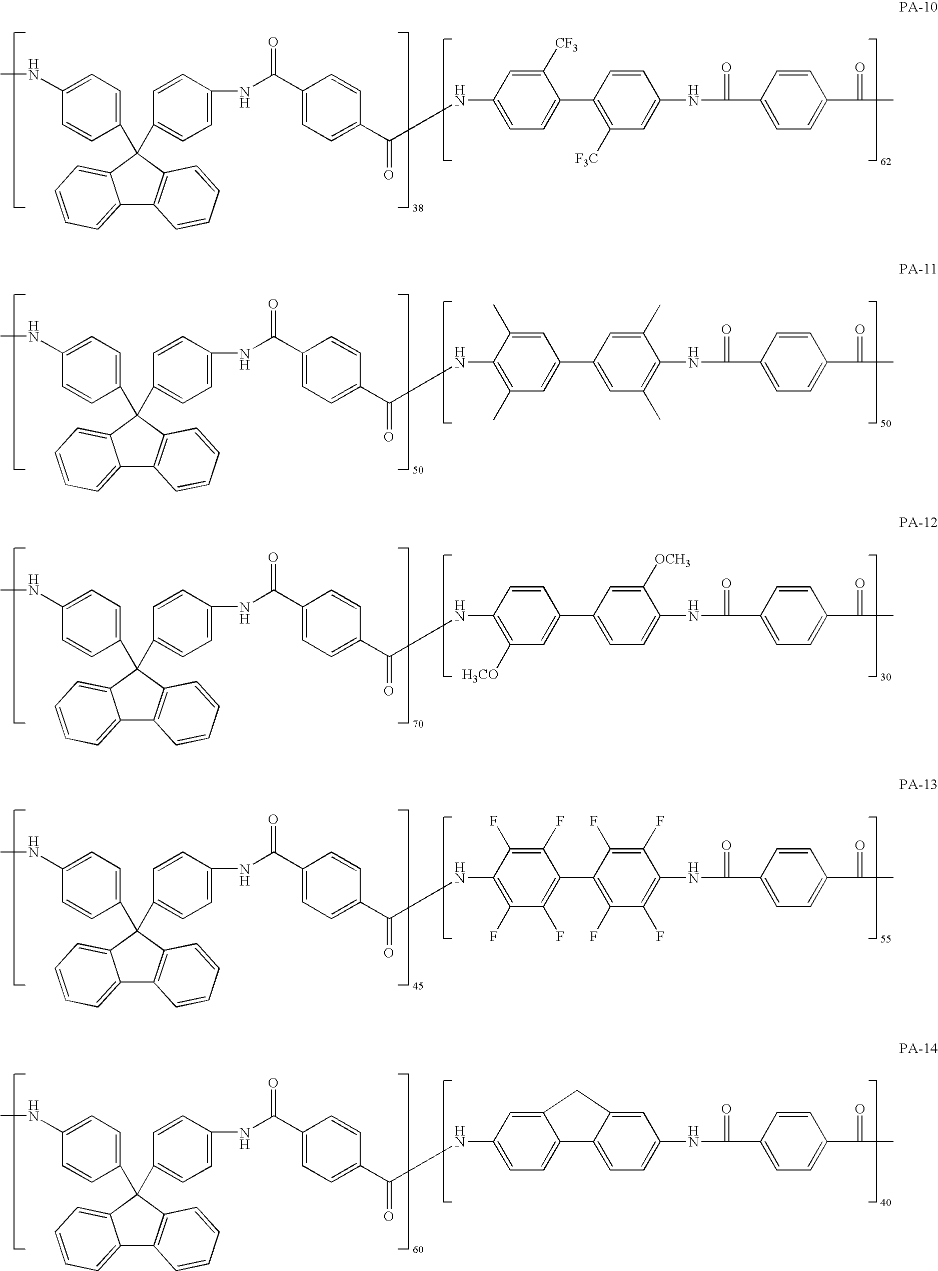

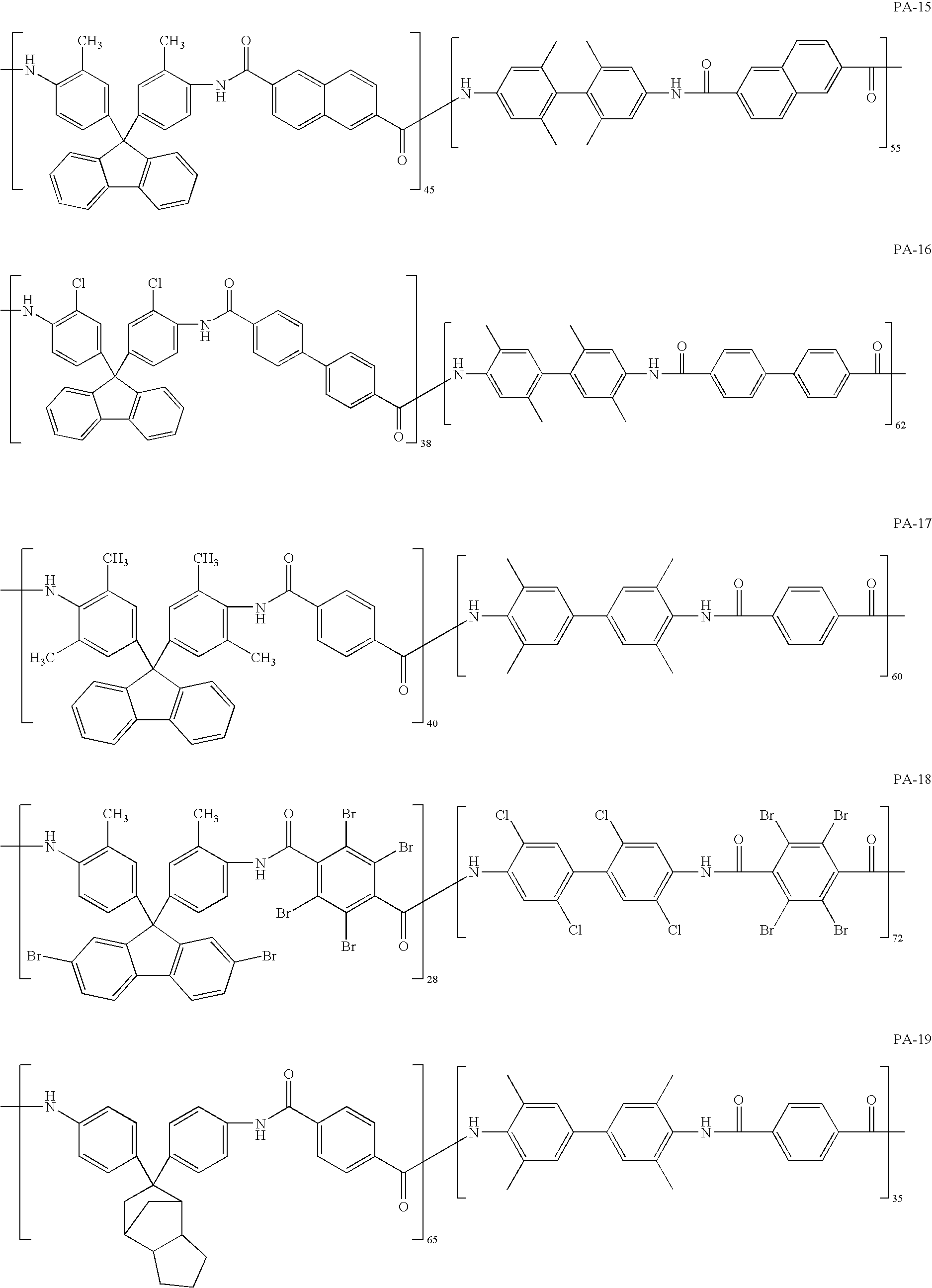

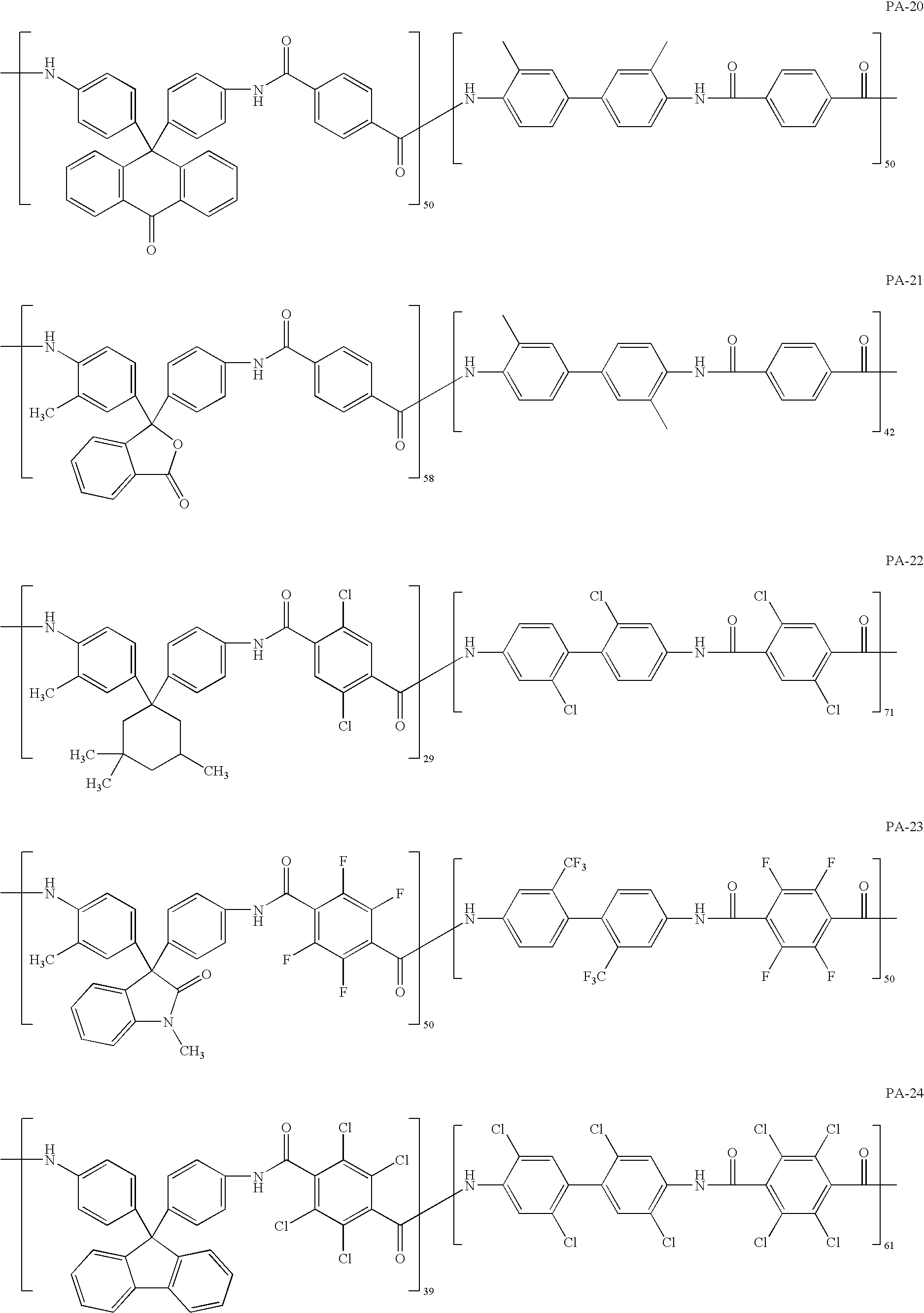

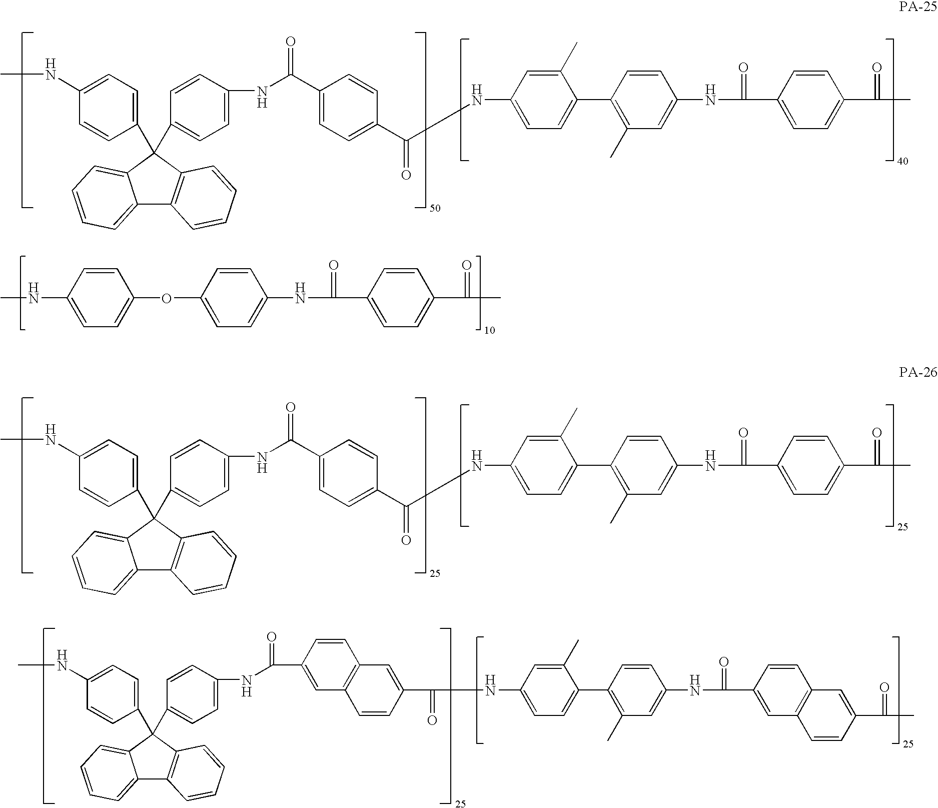

The polyamide of the invention may have one type of the repeating unit of formula (1) and one type of the repeating unit of formula (2), or may have plural types of those repeating units of formulae (1) and (2). In addition, it may be copolymerized with any other known repeating unit than the repeating units of formulae (1) and (2), not detracting from the effect of the invention. The polyamide comprising the repeating units of formulae (1) and (2) each plural types as combined may be preferred to the polyamide having the repeating units of formulae (1) and (2) each one type alone, since the former may satisfy all the requirements of good heat resistance, excellent optical properties, excellent mechanical properties and good solubility. Particularly, polyamides comprising the repeating units of formulae (1) and (2) in which each repeating unit differs in L in the formulae (1) and (2) are preferable since they generally exhibit improved solubility to solvents. Among them, more preferable are polyamides in which the combination of the different L's consists of at least two kinds selected from the group consisting of the three kinds of linking groups shown below, i.e. linking groups having the naphthylene structure, linking groups having biphenylene structure and linking groups having paraphenylene structure, since these polyamides exhibit improved solubility to solvents without sacrificing heat resistance and linear thermal expansion coefficient. In the following structures, the hydrogen atoms in the naphthylene, biphenylene and paraphenylene structures may be substituted with a substituent. Preferable substituents are an alkyl group, an aryl group and a halogen atoms and more preferable substituents are a methyl group, a chlorine atom and a bromine atom.

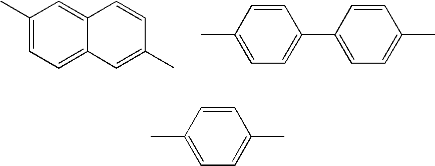

Preferably, the weight-average molecular weight of the polyamide of the invention is at least 10,000, more preferably from 20,000 to 300,000, even more preferably from 30,000 to 200,000. When the molecular weight is at least 10,000, then it is advantageous in point of the film formability of the polymer and the mechanical properties of the polymer film. On the other hand, when the molecular weight is at most 300,000, then it is also advantageous in point of the molecular weight control in polymer production, and, in addition, it is still advantageous in point of the handlability of the polymer since the viscosity of the polymer solution is not so high. In place of the molecular weight thereof, the viscosity of the polymer may also be a criterion of the polymer condition.

In any case where the polyamide of the invention has one or more different types of the repeating units of formula (1), the overall molar percentage of the repeating units of formula (1) in the polymer is from 25 to 90 mol %, preferably from 30 to 70 mol %, more preferably from 35 to 60 mol %. When the proportion of the repeating units of formula (1) in the polyamide of the invention is from 25 to 90 mol %, then the polyamide is advantageous in point of the transparency, the heat resistance and the solubility thereof.

In any case where the polyamide of the invention has one or more different types of the repeating units of formula (2), the overall molar percentage of the repeating units of formula (2) in the polymer is from 10 to 75 mol %, preferably from 30 to 70 mol %, more preferably from 40 to 65 mol %. When the proportion of the repeating units of formula (2) in the polyamide of the invention is from 10 to 75 mol %, then it is advantageous in that the linear thermal expansion coefficient of the film of the polyamide of the invention may be lowered not worsening the transparency, the heat resistance and the solubility of the film.

The repeating units other than those of formulae (1) and (2) that may constitute the polyamide of the invention are not specifically defined in point of their type so far as they do not too much detract from the effect of the invention. Particularly, incorporation of one or more repeating units other than those of formulae (1) and (2) to the polyamide of the invention may be effective in improving solubility without deteriorating heat resistance and linear thermal expansion coefficient. Preferred examples of monomers capable of forming the additional repeating units except those of formulae (1) and (2) are mentioned below in the form of diamines and dicarboxylic acids, to which, however, the monomers capable of forming the additional repeating units except those of formulae (1) and (2) in the invention should not be limited.

The diamines are paraphenylenediamine, 2-chloroparaphenylenediamine, 2,3-dichloroparaphenylenediamine, 2,5-dichloroparaphenylenediamine, 2,6-dichloroparaphenylenediamine, 2,3,5-trichloroparaphenylenediamine, 2-bromoparaphenylenediamine, 2,6-dibromoparaphenylenediamine, 2-fluoroparaphenylenediamine, 2,6-difluoroparaphenylenediamine, 2-nitroparaphenylenediamine, 2,6-dinitroparaphenylenediamine, 2-cyanoparaphenylenediamine, 2,6-dicyanoparaphenylenediamine, 2-methylparaphenyleneidiamine, 2,6-dimethylparaphenylenediamine, 2-ethylparaphenylenediamine, 3,3′-biphenylenediamine, 3,4′-biphenylenediamine, 1,4-naphthalenediamine, 1,5-naphthalenediamine, 2,6-naphthalenediamine, 1,4-bis(4-aminophenyl)benzene, metaphenylenediamine, 4-chlorometaphenylenediamine, 4,4′-diaminodiphenyl ether, 4,4′-diaminodiphenyl sulfone, 4,4′-diaminodiphenyl sulfide, 4,4′-diaminodiphenylmethane, 4,4′-diaminodiphenyl ketone, 3,3′-diaminodiphenyl ether, 3,3′-diaminodiphenyl sulfone, 3,3′-diaminodiphenyl sulfide, 3,4′-diaminodiphenyl ether. Preferred are metaphenylenediamine, 4,4′-diaminodiphenyl ether, 3,4′-diaminodiphenyl ether, 4,4′-diaminodiphenylmethane.

The dicarboxylic acids are 3,3′-biphenyldicarboxylic acid, 3,4′-biphenyldicarboxylic acid, 1,4-naphthalenedicarboxylic acid, 2,5-naphthalenedicarboxylic acid, 1,4-bis(p-benzoic acid)benzene. isophthalic acid, 4-chloroisophthalic acid, 4,6-dichloroisophthalic acid, 4-bromoisophthalic acid, 4-fluoroisophthalic acid, 4-nitroisophthalic acid, 4-methylisophthalic acid, 4-cyanoisophthalic acid.

The heat-resistant temperature of the polyamide of the invention is preferably higher, and the glass transition temperature of the polymer measured through DSC may be a criterion for it. In this case, the glass transition temperature of the polymer is preferably 300° C. or higher, more preferably 350° C. or higher, even more preferably 400° C. or higher. In case where the glass transition temperature thereof could not be substantially measured within a measurement range (for example, up to 420° C.), the polyamide of the invention is also preferred.

A method for producing the polyamide of the invention is described below.

Preferably, the polyamide of the invention is produced through polycondensation of a diamine compound and a dicarboxylic acid or its derivative corresponding to the polymer. For the polycondensation, employable is any known method of melt polycondensation; solution polycondensation to be effected in an organic solvent system in which the polymer is soluble; or interfacial polycondensation to be effected in a two-phase system of an aqueous alkali solution and a water-immiscible organic solvent. In addition, a diamine and a dicarboxylic acid may be directly reacted for direct polycondensation; or a dicarboxylic acid is once converted into its active derivative, and then this may be reacted for polycondensation. Further, there are known various methods of using a condensing agent to form an active intermediate in the reaction system. In the invention, any of these reaction modes is employable with no limitation. Above all, the solution polycondensation method of using an acid chloride of a dicarboxylic acid is preferred as it gives a polyamide having a high molecular weight in a simplified manner.

For controlling the molecular weight of the polyamide of the invention, there may be employed a method of polymerizing the monomers with varying the ratio of the functional groups of the amino group and the carboxyl group, or a method of adding a monofunctional substance to the polymerization system. Preferred examples of the monofunctional substance to be used for the molecular weight control are monoamines such as aniline; monoacid chlorides such as benzoic acid chloride. After the polymerization reaction, the polymer may be further reacted with a monoacid chloride to thereby block the terminal amine thereof. The terminal blocking makes it possible to prevent oxidative coloration of the amino group, and this reaction is preferably used herein.

The reaction solvent for use in producing the polyamide of the invention in a mode of solution polycondensation of a dicarboxylic acid chloride and a diamine is not specifically defined, but for the purpose of obtaining a high-molecular polymer, the solvent is preferably one in which the produced polymer is soluble. In general, an amide solvent such as N,N-dimethylacetamide (hereinafter referred to as DMAc) or N-methyl-2-pyrrolidone (hereinafter referred to as NMP) is much used, and in such a case, a base may be added to the reaction system, and a dissolution assistant such as LiCl, LiBr or CaCl₂ may also be added thereto. Regarding its type, the base may be any of organic bases such as triethylamine, or inorganic bases such as hydroxides or carbonates with Na, K, Li or Ca.

The amount of the remaining alkali metal and halogen in the polyamide of the invention is preferably at most 50 ppm, more preferably at most 10 ppm. When the amount of the remaining alkali metal and halogen is at most 50 ppm, then it does not worsen the electric properties of the polymer and has few influences on the surface properties of the polymer film, and, as a result, the properties of the functional films fabricated by forming a conductive film or a semiconductive film on the polymer film may be kept good. The amount of the remaining alkali metal and halogen in the polyamide of the invention may be determined in any known method of ion-chromatography, atomic absorptiometry or plasma emission spectrometry.

Also preferably, the amount of the dicarboxylic acid and the diamine remaining in the polyamide of the invention is at most 300 ppm, more preferably at most 50 ppm, even more preferably at most 10 ppm. When the amount of the remaining dicarboxylic acid and diamine is at most 300 ppm, then it does not worsen the electric properties of the polymer and has few influences on the surface properties of the polymer film, and, as a result, the properties of the functional films fabricated by forming a conductive film or a semiconductive film on the polymer film may be kept good. For example, when a transparent conductive film is formed on the polyamide film and when the amount of the dicarboxylic acid and the diamine remaining in the polyamide is at most 300 ppm, then the remaining dicarboxylic acid and diamine do neither generate gas nor thermally decompose when heated or exposed to plasma during film lamination, and therefore masses of crystal particles are not formed in the transparent conductive film, and the polyamide film can be completely coated with the transparent conductive film with no “coating failure” and the resistance of the transparent conductive film is well kept low. The amount of the dicarboxylic acid and the diamine remaining in the polyamide and in its film may be determined through known analytic method of HPLC or nuclear magnetic resonance.

### [Film]

The film of the invention is formed of the above-mentioned polyamide. For forming the polyamide of the invention into a film or a sheet, employable is any known method, but preferred is a solution casting method.

The casting and drying method in solution casting for film formation is described in U.S. Pat. Nos. 2,336,310, 2,367,603, 2,492,078, 2,492,977, 2,492,978, 2,607,704, 2,739,069, 2,739,070; British Patents 640,731, 736,892; JP-B 45-4554, 49-5614; JP-A 60-176834, 60-203430, 62-115035. As examples of the production apparatus for use in the solution casting method, there are mentioned the production apparatus described in paragraphs [0061] to [0068] and in FIG. 1 and FIG. 2 in JP-A 2002-189126, to which, however, the production apparatus usable in the invention should not be limited.

In the solution casting method, the polyamide of the invention is first dissolved in a solvent. The solvent to be used is not specifically defined so far as it dissolves the polyamide of the invention, but is preferably one capable of dissolving at least 10% by mass of a solid concentration at 25° C. Also preferably, the boiling point of the solvent for use herein is at highest 200° C., more preferably at highest 150° C. When the boiling point thereof is at highest 200° C., then the solvent may be well evaporated away and the amount of the solvent that may remain in the polymer film may be reduced as much as possible. Not detracting from the solubility of the polyamide of the invention therein, a bad solvent may be mixed in the solvent. This may be advantageous in point of the peelability and the drying speed of the film formed after the solution casting process.

The solvent usable in the invention includes methylene chloride, chloroform, tetrahydrofuran, 1,4-dioxane, benzene, cyclohexane, toluene, xylene, anisole, γ-butyrolactone, benzyl alcohol, isophorone, cyclohexanone, cyclopentanone, 1,2-dichloroethane, 1,1,2,2-tetrachloroethane, ethyl acetate, acetone, chlorobenzene, dichlorobenzene, DMAc, NMP, dimethylformamide, methanol and ethanol, to which, however, the solvent for use in the invention should not be limited. Two or more such solvents may be combined for use herein, and such a mixed solvent is preferred for use in the invention in point of both the evaporability thereof and the polymer solubility therein. Using such mixed solvent may improve the transparency of the film of the invention.

The polyamide concentration in the solution for use in the solution casting method is suitably from 5 to 60% by mass, preferably from 10 to 40% by mass, more preferably from 10 to 30% by mass. When the polyamide concentration is at least 5% by mass, then the solution may have a suitable viscosity and the thickness of the film to be formed can be readily controlled; and when it is at most 60% by mass, then the polymer solution may be formed into a good film and the film unevenness may be reduced. Before cast for film formation, the polymer solution may be optionally filtered to reduce the impurities in the film formed, and, as a result, the transmittance of the film of the invention may be improved.

The solution casting method is not specifically defined, in which, for example, a bar coater, a T-die, a bar-combined T-die, a doctor blade, a roll coater or a die coater may be used and the solution may be cast on a flat plate or on a roll.

The temperature at which the solvent is evaporated away varies depending on the boiling point of the solvent used. Preferably, the coating film is dried in two or more stages. Accordingly, a optically-uniform polyamide film can be obtained. In the first stage, the coating film is dried at 30 to 100° C. until the solvent concentration is reduced to at most 20% by mass, preferably at most 10% by mass. Next, in the second stage, the film is peeled from a flat plate or a roll, and further dried at a temperature falling between 60° C. and the glass transition temperature of the polyamide. When the film is peeled from a flat plate or a roll, it may be peeled immediately after the finish of the first stage drying or may be peeled after it is once cooled.

If the thermal drying is insufficient, then the amount of the solvent remaining in the film of the invention is large; but if the film is too much dried, then it causes pyrolysis of the polyamide. In addition, rapid thermal drying may cause rapid vaporization of the solvent, thereby resulting in formation of defects such as bubbles in the film. Preferably, the amount of the solvent remaining in the film of the invention is at most 2000 ppm, more preferably at most 1000 ppm, even more preferably at most 100 ppm. When the remaining solvent amount is at most 2000 ppm, then it is favorable in that the surface properties of the film are not worsened, the remaining solvent does not have any negative influence on the surface treatment of the film, and the properties of the functional films fabricated by forming a conductive film or a semiconductive film on the polyamide film are not worsened. The amount of the solvent remaining in the film of the invention may be determined in any known method of gas chromatography or the like.

For producing the film of the invention, preferably employed is a continuous method of casting a polymer solution onto a rotary drum or a band, peeling the coating film formed thereon, drying it and winding it around a roll. In such a case where the film of the invention is mechanically conveyed, it is desirable that the film has a high mechanical strength. The preferred mechanical strength of the film is not indiscriminately defined as varying depending on the type of the conveyor unit employed. As the criterion for it, for example, employable are the modulus of elasticity, the breaking stress and the breaking elongation that may be determined in a tensile test of the film. Preferably, the modulus of elasticity of the film is at least 2000 MPa, more preferably at least 2500 MPa, even more preferably at least 3000 MPa. The breaking stress of the film is preferably at least 60 MPa, more preferably at least 80 MPa, even more preferably at least 100 MPa. The breaking elongation of the film is preferably at least 5%, more preferably at least 10%, even more preferably at least 15%.

The film of the invention may be stretched. Stretching the film is advantageous in that the mechanical strength of the film such as the folding-resistant strength thereof may be increased and the handlability of the film is bettered. In particular, the stretched film that has an orientation release stress in the stretching direction (ASTM D1504, hereinafter referred to as ORS) of from 0.3 to 3 GPa is preferred as its mechanical strength is increased. ORS is an internal stress caused by stretching to be intrinsic to a stretched film or sheet.

For stretching the film, employable is any known method. When the polyamide of the invention has Tg of not lower than 250° C., then it could not be stretched by mere heating, and in such a case, the film may be stretched while it contains a solvent. In this case, it is desirable that the film is stretched in the course of the step of drying it. For example, the solvent-containing film may be stretched at a temperature falling between a temperature higher by 10° C. than Tg of the film and a temperature higher by 50° C. than it according to a monoaxial roll stretching method, a monoaxial tenter stretching method, a simultaneous biaxial stretching method, a successive biaxial stretching method, or an inflation method. The draw ratio is preferably from 1.1 to 3.5 times, more preferably from 1.1 to 2.0 times.

In producing the film of the invention, one or more different types of the polyamides of the invention may be used either singly or as combined. Not detracting from the effect of the invention, any other polymer than the polyamide of the invention may be used in producing the film of the invention. From the viewpoint of the solvent resistance, the heat resistance and the mechanical strength thereof, the film of the invention may contain a crosslinked resin added thereto. Regarding its type, the crosslinked resin may be selected from any known ones including thermosetting resins and radiation-curable resins, with no specific limitation.

Examples of the thermosetting resins are phenolic resin, urea resin, melamine resin, unsaturated polyester resin, epoxy resin, silicone resin, diallyl phthalate resin, furan resin, bismaleimide resin, cyanate resin. Regarding the method of crosslinking the resin, herein employable with no specific limitation is any reaction of forming a covalent bond. For example, a reaction system is employable herein with no specific limitation, which comprises reacting a polyalcohol compound and a polyisocyanate compound at room temperature to form an urethane bond. However, the system is often problematic in its pot life before film formation. In general, therefore, it is used as a two-pack system in which the polyisocyanate compound is mixed with the polyalcohol compound just before film formation.

On the other hand, when a one-pack system is used, it is effective that the functional group that participates in the crosslinking reaction is protected, for which, for example, a blocked curing agent is commercially available. Commercial products of a blocked curing agent known in the art are Mitsui Takeda Chemical's B-882N and Nippon Polyamide Industry's Coronate 2513 (these are blocked polyisocyanates); and Mitsui Cytec's Cymel 303 (methylated melamine resin). In addition, also known is a blocked carboxylic acid of the following B-1, which is a protected polycarboxylic acid usable as a curing agent for epoxy resin.

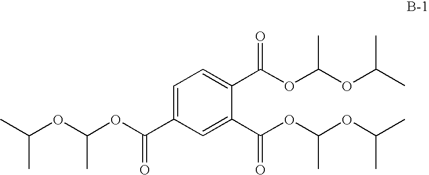

The radiation-curable resins are grouped into radical-curable resins and cation-curable resins. For the curing component of the radical-curable resin, used is a compound having plural radical-polymerizing groups in the molecule. Its typical examples are polyfunctional acrylate monomers having from 2 to 6 acrylate groups in the molecule; and urethane acrylates, polyester acrylates and epoxy acrylates having plural acrylate ester groups in the molecule.

For curing the radical-curable resin, typically mentioned are a method of irradiating the resin with electron rays, and a method of irradiating the resin with UV rays. In the method of irradiation with UV rays, generally added to the resin is a polymerization initiator capable of generating a radical through irradiation with UV rays. When a polymerization initiator capable of generating a radical under heat is added thereto, then the resin may be used as a thermosetting resin.

For the curing component of the cation-curable resin, usable is a compound having plural cation-polymerizing groups in the molecule. One typical curing method comprises adding to the resin an optical acid generator capable of generating an acid through irradiation with UV rays followed by irradiating it with UV rays to thereby cure the resin. Examples of the cation-polymerizing compound are compounds having a ring-cleaving polymerizing group such as an epoxy group, and compound having a vinyl ether group.

In the film of the invention, plural types of the above-mentioned thermosetting resins or radiation-curable resins may be combined and used, or the thermosetting resin and the radiation-curable resin may be combined and used. In addition, a crosslinking resin and a polymer not having a crosslinking group may be combined and used in the film.

The film of the invention may contain a metal oxide and/or a composite metal oxide, and a metal oxide formed through sol-gel reaction. Like the above-mentioned crosslinked resin, the oxide added to the film may improve the heat resistance and the solvent resistance of the film. Further if desired and not detracting from the effect of the invention, various resin improvers may be added to the film of the invention, including, for example, plasticizer, pigment, dye, antistatic agent, UV absorbent, antioxidant, inorganic particles, peeling promoter, leveling agent and lubricant.

Not specifically defined, the thickness of the film is preferably from 30 to 700 μm, more preferably from 40 to 200 μm, even more preferably from 50 to 150 μm. Also preferably, the haze of the film is at most 3%, more preferably at most 2%, even more preferably at most 1%. Also preferably, the whole light transmittance of the film is preferably at least 70%, more preferably at least 80%, even more preferably at least 85%. For increasing the whole light transmittance of the film, it is effective to filter the polymer solution to remove impurities from it before the solution is formed into a film in a solution casting method or the like, and to reduce the thickness unevenness of the film.

The heat-resistant temperature of the film of the invention is preferably as high as possible, for which Tg of the film measured through DSC could be a criterion. Preferably, Tg of the film is 300° C. or higher, more preferably 350° C. or higher, even more preferably 400° C. or higher. When the film of the invention is formed of the polyamide of the invention alone according to a solution casting method, then there may be little difference between Tg of the polyamide used and Tg of the film formed so far as the film formed is sufficiently dried, and the difference therebetween could be within a range of measurement error.

Preferably, the linear thermal expansion coefficient (hereinafter referred to as CTE, coefficient of thermal expansion) of the film of the invention is as low as possible, and it may be determined according to a tensile load method of thermomechanical analysis (TMA). Preferably, CTE of the film is at most 40 ppm/° C., more preferably at most 30 ppm/° C., even more preferably at most 20 ppm/° C.

Depending on its use, the film of the invention may be coated with any other layer, or the film substrate may be subjected to surface treatment of saponification, corona treatment, flame treatment, glow discharge treatment or the like for the purpose of increasing its adhesiveness to other parts. In addition, an adhesive layer and an anchor layer may be disposed on the film surface. Other various known functional layers may be imparted to the film depending on their use, for example, a smoothing layer for smoothing the film surface; a hard coat layer for improving the scratch resistance of the film surface; an UV-absorbent layer for enhancing the light fastness of the film; and a surface-roughened layer for improving the film conveyance.

A transparent conductive layer may be provided on the film of the invention. The transparent conductive layer may be any known metal film or metal oxide film. Above all, preferred is a metal oxide film in view of its transparency, conductivity and mechanical properties. For it, for example, employable are metal oxide films of indium oxide, cadmium oxide or tin oxide with an impurity of tin, tellurium, cadmium, molybdenum, tungsten, fluorine, zinc and germanium added thereto; and metal oxide films of zinc oxide or titanium oxide with an impurity of aluminium added thereto. Above all, preferred is a thin film of indium oxide comprising essentially tin oxide and containing from 2 to 15% by weight of zinc oxide, as it has good transparency and good conductivity.

For forming the transparent conductive film, any method is employable so far as it may give the intended thin film. For example, however, suitable for the film formation is a vapor-phase deposition method of depositing a material in a vapor phase, for example, a sputtering method, a vacuum vapor deposition method, an ion-plating method or a plasma CVD method. The film may be formed, for example, according to the methods described in Japanese Patent No. 3,400,324, or JP-A 2002-322561 or 2002-361774. Above all, especially preferred is a sputtering method as the film formed may have especially excellent conductivity and transparency.

In the sputtering method, the vacuum vapor deposition method, the ion-plating method and the plasma CVD method, the vacuum degree is preferably from 0.133 mPa to 6.65 Pa, more preferably from 0.665 mPa to 1.33 Pa. Before forming the transparent conductive layer thereon, it is desirable that the substrate film is subjected to surface treatment such as plasma treatment (back-sputtering) or corona treatment. During the formation of the transparent conductive layer thereon, the film may be heated at 50 to 200° C.

The thickness of the transparent conductive layer is preferably from 20 to 500 nm, more preferably from 50 to 300 nm.

The surface resistivity of the transparent conductive layer, as measured at 25° C. and at a relative humidity of 60%, is preferably from 0.1 to 200 Ω/square, more preferably from 0.1 to 100 Ω/square, even more preferably from 0.5 to 60 Ω/square. Also preferably, the light transmittance of the transparent conductive layer is at least 80%, more preferably at least 83%, even more preferably at least 85%.

Preferably, a gas-barrier layer is formed on the film of the invention for retarding the gas penetration through the film. For the gas-barrier layer, for example, preferably mentioned are metal oxides comprising, as the essential ingredient thereof, one or more metal selected from a group consisting of silicon, aluminium, magnesium, zinc, zirconium, titanium, yttrium and tantalum; metal nitrides with silicon, aluminium or boron; and their mixtures. Of those, more preferred are metal oxides comprising, as the essential ingredient thereof, a silicon oxide having a ratio of the number of oxygen atom to that of silicon atom of from 1.5 to 2.0, in view of their gas-barrier property, transparency, surface smoothness, flexibility, film stress and cost.

The inorganic gas-barrier layer may be formed, for example, according to a vapor-phase deposition method of depositing a material in a vapor phase, for example, a sputtering method, a vacuum vapor deposition method, an ion-plating method or a plasma CVD method. Above all, especially preferred is a sputtering method as the layer formed may have an especially excellent gas-barrier property. During the formation of the gas-barrier layer thereon, the film may be heated at 50 to 200° C.

Preferably, the thickness of the gas-barrier layer is from 10 to 300 nm, more preferably from 30 to 200 nm.

The gas-barrier layer may be formed on the same side as or on the opposite side to the transparent conductive layer, but is preferably formed on the opposite side thereto.

Regarding the gas-barrier property of the film with the gas-barrier layer formed thereon, the water vapor permeability through the film, as measured at 40° C. and at a relative humidity of 100%, is preferably from 0 to 5 g/m²·day, more preferably from 0 to 1 g/m²·day, even more preferably from 0 to 0.5 g/m²·day. The oxygen permeability through the film, as measured at 40° C. and at a relative humidity of 90%, is preferably from 0 to 1 ml/m²·day·atm (from 0 to 1×10⁵ ml/m²·day·Pa), more preferably from 0 to 0.7 ml/m²·day·atm (from 0 to 7×10 ml/m²·day·Pa), even more preferably from 0 to 0.5 ml/m²·day·atm (from 0 to 5×10⁴ ml/m²·day·Pa).

For further improving the barrier property thereof, the film of the invention preferably has a defect compensation layer formed adjacent to the gas-barrier layer thereof. The defect compensation layer may be formed according to (1) a method of utilizing an inorganic oxide layer formed through sol-gel reaction as in U.S. Pat. No. 6,171,663 or JP-A 2003-94572; or (2) a method of utilizing an organic substance layer as in U.S. Pat. No. 6,413,645. As described in these references, it is desirable that the defect compensation layer is formed according to a method of vapor deposition in vacuum followed by curing with UV rays or electron rays, or a method of coating followed by heating and curing through exposure to electron rays or UV rays. In the latter case of forming the layer in a coating mode, employable are various known coating methods of, for example, spraying, spin coating or bar coating.

### [Image Display Device]

The film of the invention is usable in various image display devices.

For example, the film of the invention may be used as a substrate for thin-film transistor (TFT) display devices. For fabricating TFT arrays, referred to is the method described in JP-T 10-512104 (the term “JP-T” as referred to herein means a published Japanese translation of a PCT patent application). The substrate may have a color filter for color image display. The color filter may be fabricated in any method, but is preferably fabricated through photolithography.

Optionally coated with various functional layers formed thereon, the film of the invention may be used in image display devices. The image display devices as referred to herein are not specifically defined and may be any conventional ones. Using the film of the invention gives flat panel displays of good display quality. The flat panel displays include liquid-crystal displays, plasma displays, electroluminescent (EL) displays, fluorescent character display tubes, light-emitting diodes. In addition to these, the film of the invention is also usable in other display devices heretofore having a glass substrate, as a substrate substitutive for the glass substrate in those conventional display systems. Further, the film of the invention is usable in other applications of solar cells and touch panels. Regarding the solar cells, the invention is applicable to those described in JP-A 9-148606 and 11-288745 and in Problems with New Organic Solar Cells Completely Formed of Plastics, and Their Solutions (by the Technology and Information Association of Japan, 2004). Regarding the touch panels, the invention is applicable to those described in JP-A 5-127822 and 2002-48913.

When the film of the invention is used in liquid-crystal displays, it is desirable that the polymer for the film is an amorphous polymer in order to attain the optical uniformity of the film. In addition, the birefringence of the film is preferably as small as possible, and in particular, the in-plane retardation (Re(λ)) of the film is preferably at most 50 nm, more preferably at most 30 nm, even more preferably at most 15 nm. In order to produce a film having a small birefringence from the polyamide of the invention alone, the solvent and the drying condition in the polymer solution casting process may be suitably controlled and optionally the film may be stretched for controlling its birefringence. In addition, for the purpose of controlling the retardation (Re(λ)) of the film and the wavelength-dependent dispersion thereof, resins that differ in point of the positivity or the negativity of their intrinsic birefringence may be combined, or resins having a large (or small) wavelength-dependent retardation dispersion may be combined. It is desirable that different types of resins are laminated to construct the film of the invention for the purpose of controlling the retardation (Re(λ)) of the film or for bettering the gas-barrier property and the mechanical property of the film. In addition, any known phase retarder may be combined with the film of the invention for retardation compensation. In this description, Re(λ) indicates the in-plane retardation of the film at a wavelength λ. Re(λ) may be determined by the use of Kobra 21ADH (manufactured by Oji Instruments) in which a ray having a wavelength of λ nm is led into a film in the normal line direction of the film. The wavelength λ is generally from 450 to 750 nm. In the invention, λ is 632.8 nm.

On the other hand, by controlling the optical anisotropy thereof, the film of the invention may be used as a phase retarder. In this case, the birefringence of the film may not always be small, and the film may have any desired birefringence. For producing films having a desired birefringence, employable are any known methods of, for example, stretching the film of the invention, or incorporating a compound having a birefringence into the film, or coating the film with the compound.

When the film of the invention is used in a reflection-type liquid-crystal display device, the device comprises a lower substrate, a reflective electrode, a lower alignment film, a liquid-crystal layer, an upper alignment film, a transparent electrode, an upper substrate, a λ/4 plate and a polarizing film laminated in that order from the bottom. In this, the film of the invention may be used as the λ/4 plate by controlling the optical properties thereof, or as the protective film for the polarizing film, or as any other retardation plate (e.g., viewing angle compensatory film). In view of its heat resistance, however, the film of the invention is favorably used as the substrate; and in view of its transparency, the film is also favorably used as the upper substrate with the transparent electrode and the alignment film formed thereon. If desired, a gas-barrier layer and TFT may be provided in the device. For color image display, it is desirable that a color filter layer is disposed between the reflective electrode and the lower alignment film, or between the upper alignment film and the transparent electrode.

When the film of the invention is used in a transmission-type liquid-crystal display device, the device comprises a backlight, a polarizer, a λ/4 plate, a lower transparent electrode, a lower alignment film, a liquid-crystal layer, an upper alignment film, an upper transparent electrode, an upper substrate, a λ/4 plate and a polarizing film disposed in that order from the bottom. In this, the film of the invention may be used as the λ/4 plate by controlling the optical properties thereof, or as the protective film for the polarizing film, or as any other retardation plate (e.g., viewing angle compensatory film). In view of its heat resistance, however, the film of the invention is favorably used as the substrate, and for example, it is favorably used as the substrate with the transparent electrode and the alignment film formed thereon. If desired, a gas-barrier layer and TFT may be provided in the device. For color image display, it is desirable that a color filter layer is disposed between the lower transparent electrode and the lower alignment film, or between the upper alignment film and the transparent electrode.

Not specifically defined, various display modes are proposed for liquid-crystal cells, including, for example, TN (twisted nematic), IPS (in-plane switching), FLC (ferroelectric liquid crystal), AFLC (anti-ferroelectric liquid crystal), OCB (optically compensated bend), STN (super twisted nematic), VA (vertically aligned) and HAN (hybrid aligned nematic) modes. In addition, a modified display mode is also proposed, in which any of the above-mentioned display modes are aligned and divided. The film of the invention is effective in liquid-crystal display devices of any display modes as above. In addition, the film is also effective in liquid-crystal display devices of any types of transmission, reflection and semitransmission.

These are described in JP-A 2-176625; JP-B 7-69536; MVA (SID97, Digest of Tech. Papers (preprint) 28 (1997) 854); SID99, Digest of Tech. Papers (preprint) 30 (1999) 206; JP-A11-258605; Survival (Monthly Display, Vol. 6, No. 3 (1999) 14); PVA (Asia Display 98, Proc. of the-18th-Inter. Display Res. Conf. (preprint) (1998) 383); Para-A (LCD/PDP International '99); DDVA (SID98, Digest of Tech. Papers (preprint) 29) 1998) 838); EOC (SID98, Digest of Tech. Papers (preprint) 29 (1998) 319); PSHA (SID98, Digest of Tech. Papers (preprint) 29 (1998) 1081); RFFMH (Asia Display 98, Proc. of the-18th-Inter. Display Res. Conf. (preprint) (1998) 375); HMD (SID98, Digest of Tech. Papers (preprint) 29 (1998) 702); JP-A 10-123478; WO98/48320; Japanese Patent No. 3,022477; and WO00/65384.

If desired, a gas-barrier layer and TFT may be formed on the film of the invention, and the film may be used in an organic EL device as a substrate with a transparent electrode formed thereon.

Examples of the layer constitution of an organic EL device are anode/light-emitting layer/transparent cathode; anode/light-emitting layer/electron-transporting layer/transparent cathode; anode/hole-transporting layer/light-emitting layer/electron-transporting layer/transparent cathode; anode/hole-transporting layer/light-emitting layer/transparent cathode; anode/light-emitting layer/electron-transporting layer/electron-injection layer/transparent cathode; anode/hole-injection layer/hole-transporting layer/light-emitting layer/electron-transporting layer/electron-injection layer/transparent cathode.

The organic EL device in which the film of the invention can be used may attain light emission when a direct current (optionally including an alternating current component) voltage (generally from 2 V to 40 V) or a direct current is applied thereto.

For driving the organic EL device of the type, referred to are the methods described in JP-A2-148687, 6-301355, 5-29080, 7-134558, 8-234685, 8-241047; U.S. Pat. Nos. 5,828,429, 6,023,308; and Japanese Patent No. 2,784,615.

The invention is described in more detail with reference to the following Examples, in which the material used, its amount and the ratio, the details of the treatment and the treatment process may be suitably modified or changed not overstepping the spirit and the scope of the invention. Accordingly, the invention should not be limitatively interpreted by the Examples mentioned below.

### [Method for Determination of Characteristic Values]

The characteristic values of polyamide and film were determined as follows:

### <Weight-Average Molecular Weight>

According to polystyrene-based GPC using N,N-dimethylformamide (hereinafter referred to as DMF) as a solvent, the molecular weight of a sample is determined as a value relative to that of a molecular weight-standardized polystyrene (Tosoh's HLC-8120 GPC).

### <Glass Transition Temperature (Tg)>

Measured through DSC (in nitrogen, at a heating rate of 10° C./min) (Seiko's DSC6200).

### <Whole Light Transmittance of Film>

Measured with a direct-reading haze computer by Suga Test Instruments (HGM-2DP).

### <Thickness of Film>

Measured with a dial-type thickness gauge (Anritsu's K402B).

### <Linear Thermal Expansion Coefficient (CTE) of Film>

A film sample (0.5 cm×2.0 cm piece) is prepared, and this is tested according to a tensile load method of TMA (Rigaku's TMA8310) under a tensile load condition of 100 mN.

### <Mechanical Properties of Film>

A film sample (1.0 cm×5.0 cm piece) is prepared, and is tested for the tensile strength thereof, using a tensilon (Toyo Baldwin's Tensilon RTM-25) at a pulling rate of 3 mm/min, and the modulus of elasticity, the breaking stress and the breaking elongation of the sample are determined. Three samples are tried in one test, and their data are averaged. (The sample is left at 25° C. and at a relative humidity of 60% overnight, and then used in the test. The chuck-to-chuck distance is 3 cm.)

### EXAMPLE 1

### 1. Production of Polyamide of the Invention

### Compounds PA-2, PA-3, PA-7

126 mmol of 9,9-bis(4-aminophenyl)fluorene (hereinafter referred to as BAFL), 174 mmol of m-tolidine and 500 ml of NMP were put into a reactor equipped with a stirrer, and frozen in a dry ice-acetone bath in an nitrogen steam atmosphere. 300 mmol of terephthaloyl chloride powder was put into the reactor, and with gradually dissolving in the ice bath, this was gradually stirred. Next, the stirring was continued for 4 hours, and then 30 g of LiCl was added to it. Further, 21 mmol of benzoyl chloride was added to it, and the stirring was further continued for 4 hours. Next, 800 ml of NMP was added to it, and the diluted reaction solution was led into 15 liters of distilled water with vigorously stirring it, taking 1 hour. The white precipitate formed in the distilled water was taken out through filtration, washed with 2 liters of methanol with boiling, and then again filtered. This was dried under heat at 40° C. for 12 hours, and then further dried at 70° C. under reduced pressure for 3 hours to obtain 115 g of a white powder.

Thus obtained, the white powder was analyzed for its IR absorption spectrum according to a KBr process using Nicolet's FT-IR, which confirmed the disappearance of the carbonyl stretching vibration absorption of the starting compound, terephthaloyl chloride to be seen at around 1695 cm⁻¹ but the expression of the specific absorption of an amido bond at around 1650 cm⁻¹. The molecular weight of the compound was measured through GPC (in DMF solvent), and the weight-average molecular weight thereof was 45,000. From these, the compound was identified as the polyamide of the invention, PA-2. Measuring the glass transition point of the compound was tried through DSC, but the point could not be found in the measurement temperature range of up to 420° C.

PA-3 was produced in the same manner as that for PA-2, for which, however, 129 mmol of BAFL and 171 mmol of m-tolidine were used, and 300 mmol of 4,4′-biphenyldicarboxylic acid dichloride was used in place of terephthaloyl chloride. PA-7 was produced also in the same manner as that for PA-2, for which, however, 90 mmol of BAFL was used, and 210 mmol of 2,2′,55,′-tetrachlorobenzidine was used in place of m-tolidine.

Thus obtained, the molecular weight and Tg of PA-3 and PA-7 were measured in the same manner as that for PA-2. The molecular weight of PA-3 was 67,000, and that of PA-7 was 72,000; but both the two compounds did not show Tg within the measurement temperature range of up to 420° C.

### 2. Production of Comparative Polymer BAFL-I/T

As a comparative polymer, polyamide derived from 9,9-bis(4-aminophenyl)fluorene-isophthalic acid/terephthalic acid (hereinafter referred to as “BAFL-I/T”) was produced according to the method mentioned below.

BAFL-I/T was produced in the same manner as that for PA-2, for which, however, m-tolidine was not used, 300 mmol of BAFL was used, and a mixture of 150 mmol of isophthaloyl chloride and 150 mmol of terephthaloyl chloride was used in place of terephthaloyl chloride.

Thus obtained, the molecular weight and Tg of BAFL-I/T were measured in the same manner as that for PA-2. The molecular weight of the compound was 97,000, and Tg thereof was 360° C.

### 3. Production of Comparative Polymer CPA/DAE-T

As a comparative polymer, polyamide (hereinafter referred to as “CPA/DAE-T”) described in Example 1 of Japanese Patent No. 3,185,503 was produced according to the method described in the patent specification.

2-Chloroparaphenylenediamine sulfate (0.23 mol), 3.50 g (0.0175 mol) of 4,4′-diaminodiphenyl ether, 0.871 g (0.0025 mol) of 9,9-bis(4-aminophenyl)fluorene and 600 ml of NMP were put into a 1000-ml four-neck flask and uniformly stirred and dispersed in a nitrogen stream atmosphere, and cooled to 10° C. in an ice bath. To this system, gradually added was 50.78 g (0.25 mol) of terephthalic acid chloride in such a manner that the temperature inside the flask could not be above 30° C., and after the addition, this was kept stirred for 1 hour. 25.0 g (0.25 mol) of calcium carbonate was added to the solution, and stirred at 40° C. for 3 hours for dehydrochlorination. Next, 800 ml of NMP was added to it, and the diluted reaction solution was led into 15 liters of distilled water with vigorously stirring it, taking 1 hour. The white precipitate formed in the distilled water was taken out through filtration, washed with 2 liters of methanol with boiling, and then again filtered. This was dried under heat at 40° C. for 12 hours, and then further dried at 70° C. under reduced pressure for 3 hours, and a comparative polymer CPA/DAE-T was thus obtained. CPA/DAE-T was yellowish. Measuring its molecular weight was tried through GPC (in DMF solvent), but it did not dissolve in DMF and its molecular weight could not be measured. Measuring its glass transition point was also tried through DSC, but it did not show Tg in the measurement temperature range of up to 420° C.

### 4. Production of Comparative Polymer BPFL-I/T

As a comparative polymer, polyarylate derived from 9,9-bis(4-hydroxyphenyl)fluorene-isophthalic acid/terephthalic acid (hereinafter referred to as “BPFL-I/T”) was produced according to the method mentioned below.

231.27 g (660 mmol) of 9,9-bis(4-hydroxyphenyl)fluorene, 9.171 g (33 mmol) of tetrabutylammonium chloride, 2227 ml of dichloromethane and 2475 ml of water were put into a reactor equipped with a stirrer, and stirred at 300 rpm in a water bath in a nitrogen stream atmosphere. After 30 minutes, a solution prepared by dissolving 67.0 g (330 mmol) of isophthalic acid chloride and 67.0 g (330 mmol) of terephthalic acid chloride in 743 ml of dichloromethane, and a solution prepared by diluting 693 ml of aqueous 2 mol/L (2 N) sodium hydroxide solution with 132 ml of water were dropwise added to it at the same time but via different dropping devices, taking 1 hour. After the addition, this was washed with 165 ml of water and then with 165 ml of dichloromethane. Next, stirring it was continued for 3 hours. Then, one liter of dichloromethane was added to it, and the organic phase was separated. A solution prepared by diluting 6.6 ml of 12 mol/L (12 N) hydrochloric acid with 2.5 liters of water was added to it to wash the organic phase. Further, this was washed twice with 2.5 liters of water, and then 1 liter of dichloromethane was added to the thus-separated organic phase to dilute it, and then this was led into 25 liters of methanol with vigorously stirring it, taking one hour. The white precipitate thus formed was taken out through filtration, dried under heat at 40° C. for 12 hours, and then further dried at 70° C. under reduced pressure for 3 hours, and 286 g of a comparative polymer BPFL-I/T was thus obtained.

The molecular weight of the thus-obtained BPFL-I/T was measured through GPC (in DMF solvent), and the weight-average molecular weight thereof was 237,000. Tg of the polymer, as measured through DSC, was 324° C.

### 5. Fabrication of Film Samples

### Samples 101 to 105

The polyamides of the invention, PA-2, PA-3 and PA-7, and the comparative polymers BAFL-I/T and BPFL-I/T were separately dissolved in DMAc to prepare solutions having a viscosity falling within a range of from 100 to 1500 mPa·s. Dissolving CPA/DAE-T in DMAc was tried, but the polymer did not dissolve in it and preparing the polymer solution was stopped. The resulting solutions were filtered through a 5-μm filter and then cast on a glass substrate by the use of a doctor blade. After cast, these were dried at room temperature for 2 hours and then dried under heat at 100° C. for 1 hour, and then the films were peeled from the glass plate, fitted into a frame, and dried at 200° C. for 2 hours and then at 200° C. under a reduced pressure of 133 Pa for 4 hours to obtain film samples (samples 101 to 105).

The thickness, the whole light transmittance, the modulus of elasticity, the breaking stress and the breaking elongation of the thus-obtained film samples were measured. The data are shown in Table 1 along with the molecular weight and Tg of the polymers used. In the column of the samples not showing Tg within the measurement temperature range of up to 420° C., Tg is represented by “>420”.

TABLE 1

| | | Polymer Used | | | | Physical Properties of Film | | | | | |
|---|---|---|---|---|---|---|---|---|---|---|---|
| | | | | Weight- | Glass | | | | Modulus | | |
| | | | | Average | Transition | | Thick- | | of | Breaking | Breaking |
| | | Designation | Appear- | Molecular | Temperature | Transmit- | ness | CTE | Elasticity | Stress | Elongation |
| Sample No. | | of Polymer | ance | Weight | (° C.) | tance (%) | (μm) | (ppm/° C.) | (MPa) | (MPa) | (%) |
| 101 | (comparative | BAFL-I/T | white | 97000 | 360 | 87 | 89 | 58 | 2800 | 100 | 23 |
| | sample) | | powder | | | | | | | | |
| 102 | (comparative | BPFL-I/T | white | 237000 | 324 | 85 | 83 | 65 | 2000 | 86 | 21 |
| | sample) | | powder | | | | | | | | |
| — | (comparative | CPA/DAE-T | yellow | immeasur- | >420 | film formation impossible | | | | | |
| | sample) | | powder | able | | | | | | | |
| 103 | (sample of | PA-2 | white | 45000 | >420 | 86 | 90 | 32 | 3500 | 120 | 26 |
| | the invention) | | powder | | | | | | | | |
| 104 | (sample of | PA-3 | white | 67000 | >420 | 87 | 88 | 30 | 3400 | 120 | 22 |
| | the invention) | | powder | | | | | | | | |
| 105 | (sample of | PA-7 | white | 72000 | >420 | 86 | 89 | 26 | 3600 | 130 | 25 |
| | the invention) | | powder | | | | | | | | |

As compared with the fact that CPA/DAE-T is an yellow powder and its solubility in DMAc is poor, the polyamides of the invention do not yellow and have excellent solubility.

From Table 1, it is understood that, when compared with the film having a polyamide structure that galls outside the scope of the invention (Sample 101), the film samples of the invention (Samples 103 to 105) have a higher polymer Tg and a low CTE and therefore have good heat resistance. When compared with the film having a polyarylate structure (Sample 102), it is also understood that the samples of the invention are comparable to it in point of the transmittance and are superior to it in point of Tg, CTE, the modulus of elasticity and the breaking stress.

### EXAMPLE 2

### Construction of Organic EL Device Samples 201 to 205

### 1. Formation of Gas-Barrier Layer

A target of SiO₂ was sputtered onto both surfaces of the film samples 101 to 105 fabricated in the above, according to a DC magnetron sputtering process under a vacuum of 500 Pa in an Ar atmosphere at an output power of 5 kW. Thus formed, the gas-barrier layer had a thickness of 60 nm.

### 2. Formation of Transparent Conductive Layer

While the gas-barrier layer-coated film samples were heated at 100° C., a target of ITO (In₂O₃, 95 mas. %; SnO₂, 5 mas. %) was sputtered onto them according to a DC magnetron sputtering process under a vacuum of 0.665 Pa in an Ar atmosphere at an output power of 5 kW to thereby form a transparent conductive layer of an ITO film having a thickness of 140 nm on one surface of each sample.

3. Heat Treatment of Film with Gas-Barrier Layer and Transparent Conductive Layer Formed Thereon

Assuming the disposition of TFT thereon, the film samples with a gas-barrier layer and a transparent conductive layer formed thereon were heated at 350° C. for 2 hours. Since the film sample 102 with a gas-barrier layer and a transparent conductive layer formed thereon significantly deformed in about 10 minutes, heating it was stopped.

### 4. Construction of Organic EL Devices

An aluminium lead wire was fitted to the transparent electrode layer of the film sample having a gas-barrier layer and a transparent conductive layer formed thereon and having been subjected to the heat treatment, and it was worked into a laminate structure. The film sample 101 with a transparent conductive layer formed thereon deformed a little but not remarkably, and therefore it was further worked as it was for constructing an organic EL device.

An aqueous dispersion of polyethylenedioxythiophene/polystyrenesulfonic acid (Bayer's Baytron P, having a solid content of 1.3% by mass) was applied onto the surface of the transparent electrode in a mode of spin coating and then dried in vacuum at 150° C. for 2 hours to thereby form a hole-transporting organic thin layer having a thickness of 100 nm. This is a substrate X.

On the other hand, on one surface of a temporary support of polyether sulfone (Sumitomo Bakelite's Sumilite FS-1300) having a thickness of 188 μm, a light-emitting organic thin film layer-coating solution having a composition mentioned below was applied by the use of a spin coater, and dried at room temperature to thereby form a light-emitting organic thin film layer having a thickness of 13 nm on the temporary support. This is a transfer material Y.

| | |
|---|---|
| Polyvinyl carbazole (Mw = 63000, by Aldrich) | 40 mas. pts. |
| Tris(2-phenylpyridine)/indium complex | 1 mas. pt. |
| (orthometalated complex) | |
| Dichloroethane | 3200 mas. pts. |

The substrate X and the transfer material Y were placed one upon another in such a manner that the organic thin film layer of the former could be in contact with the light-emitting organic thin film layer of the latter, heated by the use of a pair of hot rollers at 160° C. under a pressure of 0.3 MPa and at a speed of 0.05 m/min. Then, the temporary support was peeled off, and the light-emitting organic thin film layer was formed on the top of the substrate X. This is a substrate XY.

On the other hand, on one surface of a 50 μm-thick polyimide film (Ube Kosan's Upilex-50S) cut in a size of 25 mm square, a patterned mask was set for vapor deposition (the mask restricts the light-emitting area to 5 mm×5 mm), and Al was deposited onto the film in a mode of vapor deposition under a reduced atmosphere of about 0.1 mPa to thereby form an electrode having a film thickness of 0.3 μm. Using a target thereof, Al₂O₃ was deposited on the Al layer in the same pattern as that of the Al layer, in a mode of vapor deposition according to a DC magnetron sputtering process. Thus formed, the Al₂O₃ layer had a thickness of 3 nm. An aluminium lead wire was fitted to the Al electrode, and a laminate structure was thus constructed. An electron-transporting organic thin film layer-forming coating solution having a composition mentioned below was applied onto the laminate structure by the use of a spin coater, and dried in vacuum at 80° C. for 2 hours to thereby form thereon an electron-transporting organic thin film layer having a thickness of 15 nm. This is a substrate Z.

| | | |
|---|---|---|
| Polyvinyl butyral 2000 L (Mw = 2000, by | 10 | mas. pts. |
| Denki Kagaku Kogyo) | | |
| 1-Butanol | 3500 | mas. pts. |
| Electron-transporting compound having the following | 20 | mas. pts. |
| structure: | | |
| 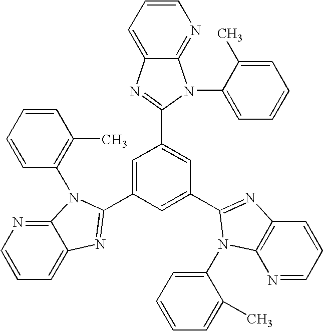 | | |

The substrate XY and the substrate Z were placed one upon another in such a manner that the electrodes of the two could face each other via the light-emitting organic thin film layer sandwiched therebetween, and laminated under heat by the use of a pair of hot rollers at 160° C. under a pressure of 0.3 MPa and at a speed of 0.05 m/min. The process gave organic EL device samples 201 and 203 to 205.

### 5. Evaluation of Organic EL Devices

Using a source measure unit Model 2400 (by Toyo Technica), a direct current voltage was applied to the organic EL device samples 201 and 203 to 205. The comparative sample 201 deformed a little emitted no light, but the samples 203 to 205 of the invention all emitted light.

The above-mentioned Examples confirm that the polyamide of the invention and the film of the invention have a high Tg and a low CTE and have good heat resistance, good transparency and excellent mechanical properties. In addition, a gas-barrier layer and a transparent conductive layer can be laminated on the film, and even though the film is subjected to heat treatment assuming the disposition of TFT thereon, it still functions as a substrate film for organic EL devices.

Since the polyamide of the invention has good heat resistance, excellent optical properties (e.g., transparency) and excellent mechanical properties, it may be used for many applications utilizing its good advantages. In addition, since the film of the invention has good heat resistance, excellent mechanical properties and excellent optical properties (e.g., transparency), it may be used for flat panel displays such as liquid-crystal displays, plasma displays, electroluminescent (EL) displays, fluorescent character display tubes, light-emitting diodes, and also for transparent conductive supports for solar cells. Further, since the film of the invention has a high glass transition temperature and a low linear thermal expansion coefficient, it may be broadly used for realizing various layer structures. Moreover, since the image display device of the invention that comprises the film has good image display quality, it may be widely used in the condition that requires image display.

The present disclosure relates to the subject matter contained in Japanese Patent Application No. 2004-269169 filed on Sep. 16, 2004, which is expressly incorporated herein by reference in its entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

1. A polyamide having from 25 to 90 mol % of a repeating unit of the following formula (1) and having from 10 to 75 mol % of a repeating unit of the following formula (2): 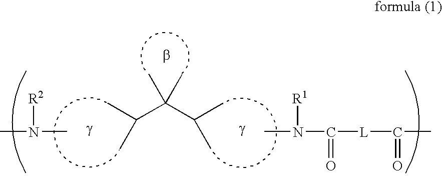
wherein the ring β and the ring γ each independently represent a monocyclic or polycyclic ring which may have a substituent; the two rings γ may be the same or different, both bonding to one quaternary carbon of the ring β; R¹ and R² each independently represent a hydrogen atom or a substituent; and L represents a linking group having a structure of any of the following: 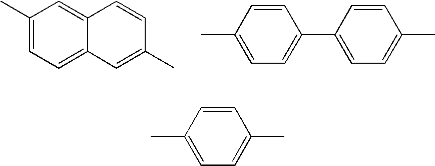
in which the hydrogen atom may be substituted, 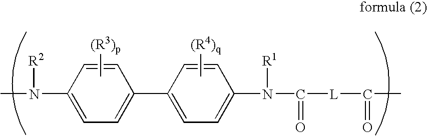
wherein R¹ and R² each independently represent a hydrogen atom or a substituent; p and q each independently indicate an integer of from 0 to 4; R³ and R⁴ each independently represent a substituent and they may bond to each other to form a ring; and L represents a linking group having a structure of any of the following: 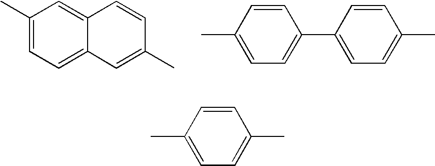
in which the hydrogen atom may be substituted.

2. The polyamide as claimed in claim 1, which has a glass transition temperature not lower than 300° C.

3. The polyamide as claimed in claim 1, wherein R¹ and R² in formula (1) each independently represent a hydrogen atom or an alkyl group.

4. The polyamide as claimed in claim 1, wherein the repeating unit of formula (1) has a structure of the following formula (3): 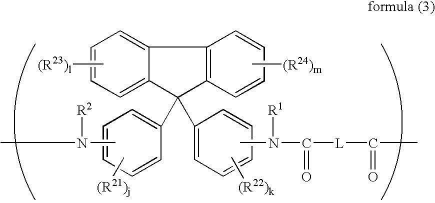
wherein R²¹, R²², R²³ and R²⁴ each independently represent a substituent, and they may bond to each other to form a ring; j, k, l and m each independently indicate an integer of from 0 to 4.

5. The polyamide as claimed in claim 1, wherein the repeating unit of formula (1) has a structure of the following formula (4): 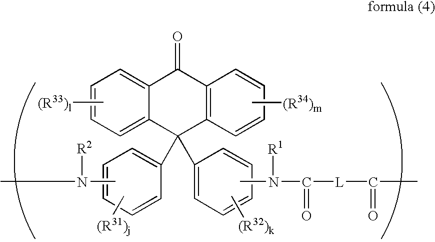
wherein R³¹, R³², R³³ and R³⁴ each independently represent a substituent, and they may bond to each other to form a ring; j, k, l and m each independently indicate an integer of from 0 to 4.

6. The polyamide as claimed claim 1, wherein R¹ and R² in formula (2) each independently represent a hydrogen atom or an alkyl group.

7. The polyamide as claimed in claim 1 which has a weight-average molecular weight of at least 10,000.

8. The polyamide as claimed in claim 1, which has a weight-average molecular weight of from 20,000 to 300,000.

9. The polyamide as claimed in claim 1, which has from 30 to 70 mol % of the repeating unit of formula (1) and has from 30 to 70 mol % of the repeating unit of formula (2).

10. The polyamide as claimed in claim 1, which has from 35 to 60 mol % of the repeating unit of formula (1) and has from 40 to 65 mol % of the repeating unit of formula (2).

11. A film comprising the polyamide of claim 1.

12. The film as claimed in claim 11, which has a whole light transmittance of at least 70%.

13. The film as claimed in claim 11, which has a thickness of from 30 to 700 μm.

14. The film as claimed in claim 11, which has a haze of at most 3%.

15. The film as claimed in claim 11, which has a linear thermal expansion coefficient of at most 40 ppm/° C.

16. The film as claimed in claim 11, which has a glass transition temperature not lower than 300° C.

17. The film as claimed in claim 11, which has a gas-barrier layer laminated on at least one surface thereof.

18. The film as claimed in claim 11, which has a transparent conductive layer laminated on at least one surface thereof.

19. An image display device comprising the film of claim 11.

20. The image display device as claimed in claim 19, which is an organic EL device.
